(19) United States
(12) Patent Application Publication
(10) Pub. No.: US 2007/0072783 A1
(43) Pub. Date: Mar. 29, 2007

(54) Scour medium for titanium dioxide production

(75) Inventor: Harry E. Flynn, Edmond, OK (US)

Correspondence Address: William B. Miller, 123 Robert S. Kerr Avenue, Oklahoma City, OK, 73102, US

(73) Assignee: Tronox LLC

(21) Appl. No.: 11/234,996

(22) Filed: Sep. 26, 2005

(51) Int. Cl. C09D 9/00

(52) U.S. Cl. 510/201

(57) ABSTRACT

A blend of anatase and rutile titanium dioxides is calcined to a crush strength and density meeting the requirements for an acceptable scour medium in a chloride process for producing rutile titanium dioxide pigments. By using such a blend, a greater conversion of the anatase titanium dioxide can be realized than would be observed under the same calcination conditions were only anatase titanium dioxide calcined, so that a significant proportion of the less costly and less valuable anatase titanium dioxide can be used and the scour medium employed at customary rates of addition, without requiring separation of the scour medium from the produced rutile titanium dioxide and while keeping the rutile content of the combined spent scour medium and produced rutile titanium dioxide at about 99 percent and greater by weight.

### FIELD OF THE INVENTION

The present invention generally relates to the production of rutile titanium dioxide pigments. More specifically, the present invention relates to the use of raw (base or unfinished) anatase pigment, such as screened from a calciner discharge in a sulfate process for making titanium dioxide pigments, in making an improved scour medium for the production of rutile titanium dioxide according to a chloride process.

### BACKGROUND AND SUMMARY OF THE INVENTION

In the chloride process for making titanium dioxide, titanium tetrachloride is oxidized in the vapor phase, in an oxidation reactor, to form rutile titanium dioxide. The titanium dioxide and other reaction products typically are then passed through an externally cooled conduit where they are cooled and coalesced. The titanium dioxide particles primarily form in the gas phase, but due to forces such as thermophoresis and turbulence, the titanium dioxide particles can be swept to the walls of the reactor. Once the particles reach the wall they tend to adhere and build up. Similarly, solid deposits can adhere and build up on the internal walls of the cooling conduit. The buildup of titanium dioxide particles reduces the heat transfer from the process, which causes cooling problems. Moreover, this buildup can eventually plug up the equipment, stopping the flow entirely and necessitating a shutdown for cleaning.

In order to prevent the deposition and buildup of titanium dioxide, various scour media are typically introduced into the oxidation reactor or the cooling conduit. The purpose of the scour media is to behave as scrubbing material and keep the walls of the reactor and cooling conduit free of titanium dioxide deposits without causing noticeable material abrasion on the internal surfaces. Thus, desirable scour media are hard enough to scour the walls of a reactor, but not so hard or abrasive such that the media wear away the walls of the oxidation reactor or the cooling conduit. Various types of material have been used as scour media, such as compressed titanium dioxide pigment, mixtures of titanium dioxide and water which are pelletized, sand, aluminum oxide, zirconium oxide, and salts, for example.

Preferable scour media will be sufficiently inexpensive and sufficiently compatible with the produced pigment (that is, titanium dioxide) such that the scour media need not be separated from the product. For example, when salt is used as a scour medium, it is typically dissolved and washed away. Other scour media, such as sand, must be separated from the pigment stream due to the media's value or tendency to contaminate the pigment.

Applicant discovered, in accordance with commonly-assigned, copending U.S. patent application Ser. No. 10/838,914 of the same name, filed May 4, 2004, that calcining a raw (base or unfinished) anatase pigment such as screened from a calciner discharge in a sulfate process to a crush strength and density meeting the requirements for an acceptable scour medium, resulted in a conversion of a portion of the anatase pigment to rutile. This calcined anatase could, consequently, be utilized as a scour medium in the chloride process for producing rutile titanium dioxide within limits on the anatase content of the rutile pigment, depending on the degree of conversion realized from anatase to rutile. However, in practical terms even at relatively high single pass conversion rates (for anatase to rutile), for typical scour medium usage rates of from 2 to 10% by mass of the pigment flow more anatase content is present than desired, for example, on the order of about 1% and greater. More stringent calcination conditions produce a higher per-pass conversion to the rutile form, but tend to adversely affect the crush strength and bulk density of the resulting scouring medium and so do not provide a satisfactory solution.

### SUMMARY OF THE INVENTION

The present invention concerns the further discovery that by blending rutile titanium dioxide with the base anatase titanium dioxide prior to its calcination, a higher per-pass conversion of the anatase titanium dioxide to rutile occurs than were anatase titanium dioxide used entirely. Without in any sense limiting the present invention, the rutile titanium dioxide thus seems to behave as a catalyst or as a seed material for the anatase to rutile conversion, in the end providing a scour medium useful in a chloride process for making rutile titanium dioxide pigments, which scour medium has the desired crush strength and bulk density but an anatase content in the range of that conventionally exhibited in the production of commercial-grade rutile titanium dioxide pigments. The scour medium thus formed can as a result be used in the usual desired proportions in relation to the pigment flow, preferably without contributing to a reduction in the rutile content of the product and a corresponding increase in its anatase content.

### DETAILED DESCRIPTION OF PREFERRED EMBODIMENTS OF THE INVENTION

Preferably, to be used as a scour medium according to the present invention the calcined rutile/anatase blend will have a density of at least about 1.55 g/cm³ and no more than about 1.71 g/cm³. Further, the scour medium will preferably have a crush strength of less than about 30 and a crush strength greater than about 15, where the indicated crush strength is measured in percent using a 4K Crush test (that is, API RP60).

As has been mentioned above, it would be desirable to be able to use the calcined anatase/rutile blends as scour media at typical rates of addition for scour media, namely, from 2 to 10% of the pigment mass flow, while also maintaining the anatase content of the resulting titanium dioxide product (including the spent scour medium) below about 1 percent by weight. More preferably, the conversion of the anatase portion of the anatase/rutile blend calcined for the scour medium will be such that the anatase content of the titanium dioxide product from oxidization will be less than about 0.5 percent by weight. Most preferably, the anatase content of the titanium dioxide product will be on the order of about 0.2 percent by weight.

We have found that by calcining anatase/rutile blends rather than simply anatase pigment (such as screened and recovered from a calciner discharge in a sulfate process for making titanium dioxide, for example), sufficiently greater conversions can be achieved of the anatase portion than would be seen starting just with the anatase pigment, and that the considerably less costly or valuable anatase portion of the blend can still be at least about 50 percent by weight of the blend. More preferably, with proper selection of the calcinations conditions, the anatase portion of the blends can be at least about 75 percent by weight of the blend. Most preferably, the anatase portion of the blend can be at least about 90 percent by weight of the blend. However, in principle, because anatase pigments are of lesser commercial value generally, any use of anatase in replacement of the rutile titanium dioxide will provide cost benefits and will be worthwhile, for example, as little as 10 percent by weight of the anatase material.

The calcination of the anatase/rutile blends leading to the scour medium of the present invention will be well within the capabilities of those skilled in the art, and the methods and apparatus which have long been used for calcination in the production of sulfate grade anatase titanium dioxide pigments should be equally available for use with the anatase/rutile blends of the present invention. For example, the calcined anatase/rutile blends useful as scour media in accordance with the present invention can be produced by starting with anatase and rutile titanium dioxides in the desired proportion and agglomerating with water to form pellets. The pellets are then dried and screened to remove pellet sizes that are undesirably too large or undesirably too small. The pellets are then calcined in a rotary calciner at the determined temperature for an amount of time (that is, the residence time) sufficient to calcine the anatase/rutile blend and provide the needed crush strength and bulk density. The temperature and residence time for calcining may vary depending on the particular anatase and rutile titanium dioxides used and on the proportions of each, as well as on the needed conversion of anatase to rutile given how much anatase can remain in the ending rutile titanium dioxide pigment product. Those skilled in the art will, however, be able to determine the appropriate conditions for a given combination of the anatase and rutile titanium dioxides without undue experimentation.

The calcined scour medium is then useful in a process for the production of rutile titanium dioxide pigment. Methods for introducing scour media into such a process are known in the art. For example, scour media according to the present invention can be introduced into an oxidation reactor used in the chloride process for producing rutile titanium dioxide. Alternately, scour media according to the present invention can be introduced into cooling conduits used in the chloride process for producing rutile titanium dioxide.

The present invention is more particularly illustrated by the following examples, in which various calcination temperatures and residence times are used for calcining (in a conventional rotary calciner) an anatase titanium dioxide “A” on the one hand and a 55:45 blend by weight of the same anatase titanium dioxide “A” with a rutile titanium dioxide “B”, and the bulk density and 4K crush strengths determined for the resulting calcined scour medium. As may be observed from the results shown in Tables 1 and 2 below, the addition of rutile results in a greater conversion of the anatase portion of the blend when calcined and a greater rutile content in the resultant scour medium than expected based on anatase conversion rates, were the starting material only anatase titanium dioxide. Further, the 55:45 blend when calcined at 1100 degrees Celsius produced a material that was just outside the preferred crush strength range (in which higher numbers indicate a softer material) of from about 15 to about 30 percent, yet that was 94.6 percent rutile. A higher calcination temperature should result in a still greater conversion of the anatase titanium dioxide to rutile form as well as a greater crush strength within the preferred range.

TABLE 1
Anatase A Only

| Calcining | Residence | Bulk | 4K Crush | |
|---|---|---|---|---|
| Temp. | Time | Density | Strength | |
| (deg. C.) | (minutes) | (g/cc) | (pct) | Pct. Rutile |
| 1050 | 30 | 1.36 | 51.2 | 3 |
| 1100 | 30 | 1.59 | 11.7 | 84.3 |

TABLE 2
Anatase A/Rutile B

| | | | | | Theoretical Pct. |
|---|---|---|---|---|---|
| Calcining | Residence | Bulk | 4K Crush | | Rutile, Based on |
| Temp. | Time | Density | Strength | Pct. | Anatase Only |
| (deg. C.) | (minutes) | (g/cc) | (pct) | Rutile | Conversion Rates |
| 1050 | 30 | 1.51 | 52 | 87.1 | 56.4 |
| 1075 | 30 | 1.67 | 44.3 | 90 | |
| 1100 | 30 | 1.79 | 35.7 | 94.6 | 92.9 |

The present invention in sum provides for scour media that can be effectively utilized in the chloride process for production of rutile titanium dioxide without having to be separated or recovered from the final product. While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and by equivalents thereto.

What is claimed is:

1. A method for reducing titanium dioxide buildup in equipment used for the production of titanium dioxide, comprising the steps of:
calcining a blend of anatase and rutile titanium dioxides to produce a scour medium;
and introducing the scour medium into the equipment used for the production of titanium dioxide.

2. The method of claim 1, wherein the calcining step takes place at a temperature greater than about 1025° C.

3. The method of claim 1, wherein the blend is calcined to a crush strength between about 15 percent and about 30 percent.

4. The method of claim 1, wherein the blend is calcined to a density of from about 1.55 g/cm3 to about 1.71 g/cm3.

5. The method of claim 1, wherein the calcined blend is introduced into an oxidation reactor.

6. The method of claim 1, wherein the calcined blend is introduced into a cooling conduit.

7. The method of claim 1, wherein the blend is at least about 10 percent anatase by weight.

8. The method of claim 1, wherein the blend is at least about 50 percent anatase by weight.

9. The method of claim 1, wherein the blend is at least about 75 percent anatase by weight.

10. The method of claim 1, wherein the blend is at least about 90 percent anatase by Case No. weight.

11. The method of claim 1, wherein the proportions of the anatase and rutile titanium dioxides in the blend are selected and calcinations conditions employed to effect at least that degree of conversion of the anatase titanium dioxide in the blend which enables an anatase content of less than about 1 percent by weight of the combined produced titanium dioxide and spent scouring medium, when the scour medium is used to an extent whereby it comprises from about 2 to about 10 percent of the mass flow through the production equipment for producing said titanium dioxide.

12. The method of claim 11, wherein the anatase content of the produced titanium dioxide and spent scouring medium is maintained at less than about 0.5 percent by weight.

13. The method of claim 11, wherein the anatase content of the produced titanium dioxide and spent scouring medium is maintained at less than about 0.2 percent by weight.
